(19) United States
(12) Patent Application Publication
(10) Pub. No.: US 2016/0055955 A1
(43) Pub. Date: Feb. 25, 2016

(54) CHIP ELECTRONIC COMPONENT

(71) Applicant: SAMSUNG ELECTRO-MECHANICS CO., LTD., Suwon-Si (KR)

(72) Inventors: Ki Hyun PARK, Suwon-Si (KR); Jeong Hyun PARK, Suwon-Si (KR)

(21) Appl. No.: 14/677,782

(22) Filed: Apr. 2, 2015

(30) Foreign Application Priority Data
Aug. 22, 2014 (KR) 10-2014-0109510

(51) Int. Cl. H01F 27/255; H01F 27/29; H01F 27/28

(52) U.S. Cl. CPC H01F 27/255; H01F 27/2804; H01F 27/29

(57) ABSTRACT

There is provided a chip electronic component including: a magnetic body containing magnetic metal powder particles; an internal coil part embedded in the magnetic body; and a plating spreading prevention layer disposed on at least one of upper and lower surfaces of the magnetic body, wherein the plating spreading prevention layer contains magnetic powder particles, and a D₅₀ of the magnetic powder particles contained in the plating spreading prevention layer is 0.1 μm to 3.5 μm.

### CROSS-REFERENCE TO RELATED APPLICATION

This application claims the priority and benefit of Korean Patent Application No. 10-2014-0109510 filed on Aug. 22, 2014, with the Korean Intellectual Property Office, the disclosure of which is incorporated herein by reference.

### BACKGROUND

The present disclosure relates to a chip electronic component.

An inductor, one of chip electronic components, is a representative passive element configuring an electronic circuit together with a resistor and a capacitor to remove noise.

A thin film type inductor is manufactured by forming internal coil parts and then hardening a magnetic powder-resin composite in which magnetic powder and a resin are mixed with each other.

### RELATED ART DOCUMENT

(Patent Document 1) Japanese Patent Laid-Open Publication No. 2008-166455

### SUMMARY

An aspect of the present disclosure may provide a chip electronic component capable of preventing a plating spreading phenomenon occurring on surfaces thereof at the time of forming external electrodes.

According to an aspect of the present disclosure, a chip electronic component may include: a magnetic body containing magnetic metal powder particles; an internal coil part embedded in the magnetic body; and a plating spreading prevention layer disposed on at least one of upper and lower surfaces of the magnetic body, wherein the plating spreading prevention layer contains magnetic powder particles, and a D₅₀ of the magnetic powder particles contained in the plating spreading prevention layer is 0.1 μm to 3.5 μm.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view showing a chip electronic component according to an exemplary embodiment of the present disclosure so that internal coil parts of the chip electronic component are viewed;

FIG. 2 is a cross-sectional view taken along line I-I′ of FIG. 1;

FIG. 3 is an enlarged schematic view of an example of part ‘A’ of FIG. 2;

FIG. 4 is an enlarged schematic view of another example of part ‘A’ of FIG. 2; and

FIG. 5 is an enlarged schematic view of another example of part ‘A’ of FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

### Chip Electronic Component

Hereinafter, a chip electronic component according to an exemplary embodiment of the present disclosure, particularly, a thin film type inductor will be described. However, the present disclosure is not necessarily limited thereto.

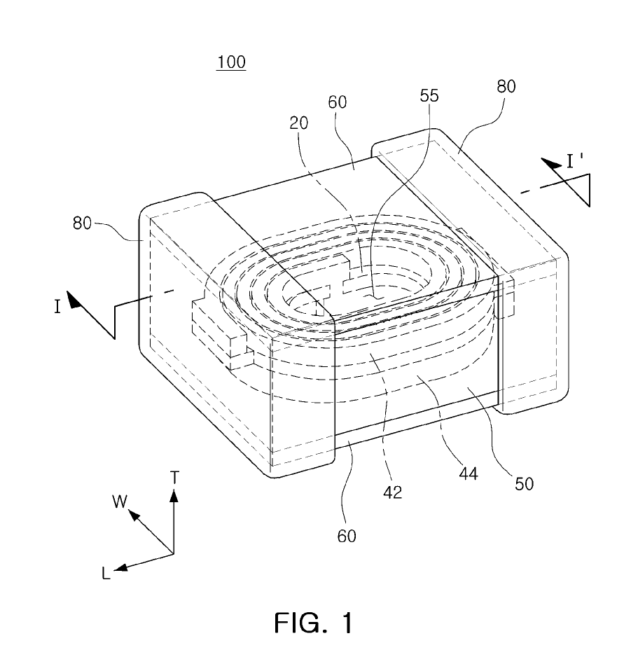

FIG. 1 is a schematic perspective view showing a chip electronic component according to an exemplary embodiment of the present disclosure so that internal coil parts of the chip electronic component are viewed.

Referring to FIG. 1, a thin film type inductor 100 used in a power line of a power supplying circuit is disclosed as an example of the chip electronic component.

The chip electronic component 100 according to an exemplary embodiment of the present disclosure may include a magnetic body 50, internal coil parts 42 and 44 embedded in the magnetic body 50, and plating spreading prevention layers 60 disposed on upper and lower surfaces of the magnetic body 50, and external electrodes 80 disposed on outer surfaces of the magnetic body 50 and electrically connected to the internal coil parts 42 and 44.

In the chip electronic component 100 according to an exemplary embodiment of the present disclosure, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The magnetic body 50 may contain magnetic metal powder particles.

The magnetic metal powder particles may be an alloy containing one or more selected from the group consisting of Fe, Si, Cr, Al, and Ni. For example, the magnetic metal powder particles may contain Fe—Si—B—Cr based amorphous metal particles, but are not limited thereto.

The magnetic metal powder particles may be contained in a thermosetting resin such as an epoxy resin, a polyimide resin, or the like, in a form in which they are dispersed in the thermosetting resin.

In order to improve a packing factor of the magnetic metal powder particles contained in the magnetic body 50, two or more kinds of magnetic metal powder particles having different particle sizes may be mixed with each other in a predetermined ratio.

Magnetic metal powder particles having a large particle size and a high magnetic permeability are used in order to obtain a high inductance in a defined unit volume, and magnetic metal powder particles having a small particle size are mixed with the magnetic metal powder particles having the large particle size to improve a packing factor, whereby a high magnetic permeability may be secured and an efficiency decrease due to core loss at a high frequency and a high current may be prevented.

However, in the case in which the magnetic metal powder particles having the large particle size and the magnetic metal powder particles having the small particle size are mixed with each other as described above, a surface roughness of the magnetic body may become large. Particularly, the magnetic metal powder particles having the large particle size may protrude on a surface of the magnetic body in a process of polishing the magnetic body cut at an individual chip size, and an insulating coating layer at a protrusion portion may be peeled off.

Therefore, at the time of forming plating layers of the external electrodes later, a plating spreading defect that the plating layers are formed on the magnetic metal powder particles at which the insulating coating layer is peeled off may occur.

Therefore, in an exemplary embodiment of the present disclosure, the plating spreading prevention layer 60 formed of fine powder particles having a small particle size may be formed on at least one of the upper and lower surfaces of the magnetic body 50 to solve the above-mentioned problem.

An insulating substrate 20 disposed in the magnetic body 50 may have the internal coil parts 42 and 44 formed on one surface and the other surface thereof, respectively, wherein the internal coil parts 42 and 44 have coil shaped patterns.

The insulating substrate 20 may be, for example, a polypropylene glycol (PPG) substrate, a ferrite substrate, a metal based soft magnetic substrate, or the like.

The insulating substrate 20 may have a through-hole formed in a central portion thereof so as to penetrate through the central portion thereof, wherein the through-hole may be filled with magnetic metal powder particles to form a core part 55. The core part 55 filled with the magnetic metal powder particles may be formed to improve an inductance.

The internal coil parts 42 and 44 may include coil patterns formed in a spiral shape, and the internal coil parts 42 and 44 formed on one surface and the other surface of the insulating substrate 20, respectively, may be electrically connected to each other through a via electrode formed in the insulating substrate 20.

The internal coil parts 42 and 44 and the via electrode may be formed of a metal having excellent electrical conductivity, for example, silver (Ag), palladium (Pd), aluminum (Al), nickel (Ni), titanium (Ti), gold (Au), copper (Cu), platinum (Pt), or an alloy thereof, etc.

One end portion of the internal coil part 42 formed on one surface of the insulating substrate 20 may be exposed to one end surface of the magnetic body 50 in the length direction thereof, and one end portion of the internal coil part 44 formed on the other surface of the insulating substrate 20 may be exposed to the other end surface of the magnetic body 50 in the length direction thereof.

The external electrodes 80 may be formed on both end surfaces of the magnetic body 50 in the length direction thereof, respectively, so as to be connected to the internal coil parts 42 and 44 exposed to both end surfaces of the magnetic body 50 in the length direction thereof, respectively.

The external electrodes 80 maybe formed of a conductive metal having excellent electrical conductivity, for example, nickel (Ni), copper (Cu), tin (Sn), or silver (Ag), or an alloy thereof, etc.

The external electrode 80 maybe formed using conductive pastes containing the conductive metal and may be formed by, for example, a dipping method, or the like. The external electrode 80 may include an electrode layer formed using a conductive paste and a plating layer formed on the electrode layer by a plating process.

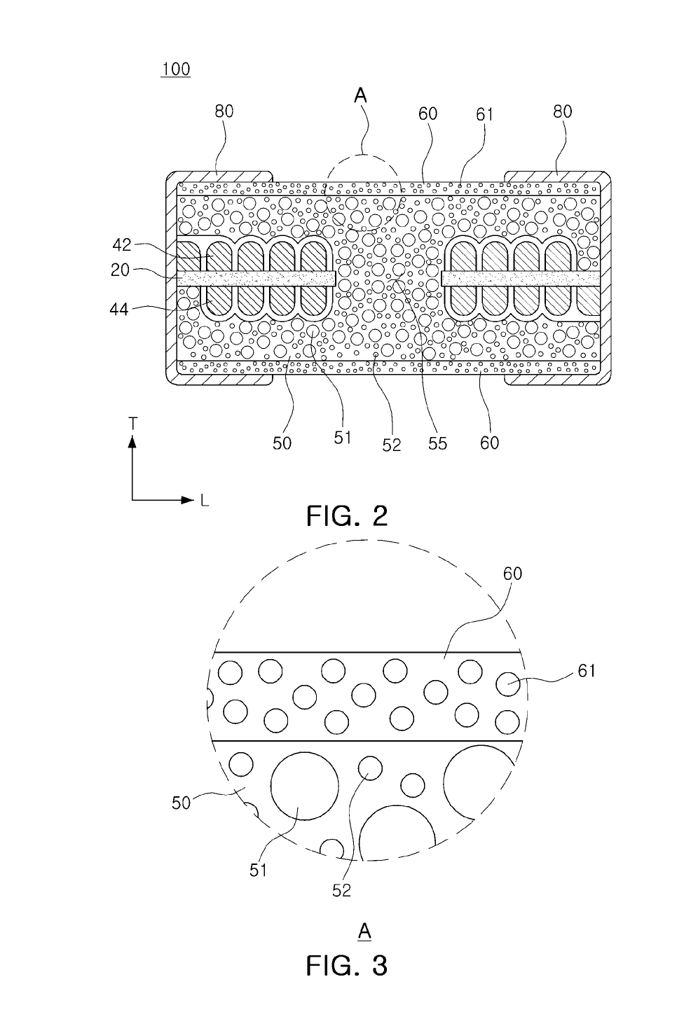

FIG. 2 is a cross-sectional view taken along line I-I′ of FIG. 1.

Referring to FIG. 2, the magnetic body 50 according to an exemplary embodiment of the present disclosure may contain mixtures of first magnetic metal powder particles 51 and second magnetic metal powder particles 52 having a D₅₀ smaller than that of the first magnetic metal powder particles 51.

The first magnetic metal powder particles 51 having a large D₅₀ may have a high magnetic permeability, and the first magnetic metal powder particles 51 having the large D₅₀ and the second magnetic metal powder particles 52 having the small D₅₀ maybe mixed with each other to improve a packing factor, whereby a magnetic permeability may be further improved and a quality (Q) factor may be improved.

The D₅₀ of the first magnetic metal powder particles 51 may be 18 μm to 22 μm, and the D₅₀ of the second magnetic metal powder particles 52 may be 2 μm to 4 μm.

D₅₀ may be measured using a particle size distribution measuring apparatus using a laser diffraction scattering method.

A particle size of the first magnetic metal powder 51 may be 11 μm to 53 μm, and a particle size of the second magnetic metal powder 52 may be 0.5 μm to 6 μm.

The magnetic body 50 may contain the mixtures of the first magnetic metal powder particles 51 having a large average particle size and the second magnetic metal powder particles 52 having an average particle size smaller than that of the first magnetic metal powder particles 51.

According to an exemplary embodiment of the present disclosure, fine powder cover layers 60 formed of the fine powder particles may be formed on the upper and lower surfaces of the magnetic body 50 to serve as the plating spreading prevention layers.

The fine powder cover layer and the plating spreading prevention layer may be the same component. Therefore, hereinafter, only the plating spreading prevention layer will be described.

In the case of using magnetic metal powder particles, which are coarse powder particles, in order to have a high magnetic permeability, the magnetic metal powder particles, which are the coarse powder particles, may be exposed on the surface of the magnetic body 50, and a defect that a plating layer is formed in exposed portions of the magnetic metal powder particles, which are the coarse powder particles, in a plating process of forming the plating layer of the external electrodes may occur.

However, in an exemplary embodiment of the present disclosure, the plating spreading prevention layers 60 formed of the fine powder particles may be formed on the upper and lower surfaces of the magnetic body 50 to improve a surface roughness of the magnetic body 50 and prevent a plating spreading phenomenon due to the coarse powder particles.

The plating spreading prevention layer 60 may contain magnetic powder particles 61.

Since the plating spreading prevention layer 60 may contain magnetic powder particles having soft magnetism or ferromagnetism, a decrease in an inductance generated due to a decrease in a thickness of the magnetic body may be prevented by forming the plating spreading prevention layer 60. That is, the plating spreading prevention layer 60 may contain the magnetic powder particles 61 to prevent the plating spreading phenomenon and contribute to forming an inductance.

The magnetic powder 61 contained in the plating spreading prevention layer 60 may be one or more selected from the group consisting of a magnetic metal powder and ferrite, but is not necessarily limited thereto. That is, any material having a magnetic property may be contained in the plating spreading prevention layer 60.

The magnetic metal powder may be a crystalline or amorphous metal containing one or more selected from the group consisting of Fe, Si, Cr, Al, and Ni.

The ferrite may be Mn—Zn based ferrite, Ni—Zn based ferrite, Zn—Cu based ferrite, Ni—Zn—Cu based ferrite, Mn—Mg based ferrite, Ba based ferrite, Li based ferrite, or the like.

The plating spreading prevention layer 60 may have a thickness of 15 μm or less.

In the case in which the thickness of the plating spreading prevention layer 60 exceeds 15 μm, a thickness of the magnetic body may be significantly decreased, such that an inductance may be significantly decreased.

FIG. 3 is an enlarged schematic view of an example of part ‘A’ of FIG. 2.

Referring to FIG. 3, the magnetic powder particles 61 contained in the plating spreading prevention layer 60 may be fine powder particles having a D₅₀ of 1.0 μm to 3.5 μm.

In the case in which the D₅₀ of the magnetic powder particles 61 contained in the plating spreading prevention layer 60 is less than 0.1 μm, a packing factor and a magnetic permeability may be decreased, such that an inductance may be decreased, and in the case in which the D₅₀ of the magnetic powder particles 61 contained in the plating spreading prevention layer 60 exceeds 3.5 μm, improvement of the surface roughness of the magnetic body may be insufficient, such that the plating spreading phenomenon may occur.

Each of the magnetic powder particles 61 contained in the plating spreading prevention layer 60 may have a particle size of 0.03 μm to 10 μm.

The plating spreading prevention layer 60 may further contain a thermosetting resin, and the magnetic powder particles 61 may be contained in a thermosetting resin such as an epoxy resin, a polyimide resin, or the like, in a form in which they are dispersed in the thermosetting resin.

A content of the thermosetting resin contained in the plating spreading prevention layer 60 may be 15 wt % to 30 wt %.

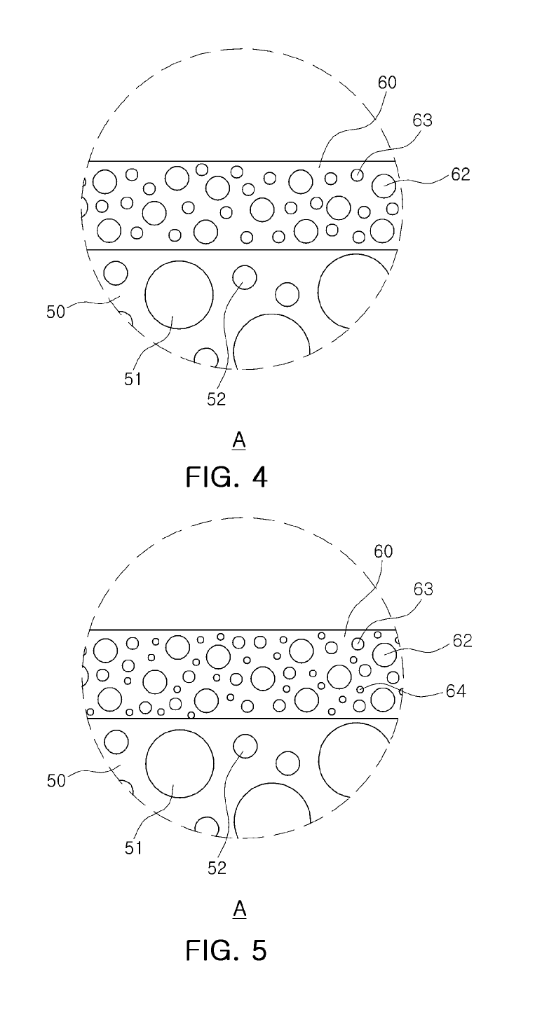

FIG. 4 is an enlarged schematic view of another example of part ‘A’ of FIG. 2.

Referring to FIG. 4, the plating spreading prevention layer 60 may contain mixtures of first magnetic powder particles 62 and second magnetic powder particles 63 having a D₅₀ smaller than that of the first magnetic powder particles 62.

As described above, the first and second magnetic powder particles 62 and 63 having different D₅₀ may be mixed with each other to improve a packing factor. The packing factor of the magnetic powder particles contained in the plating spreading prevention layer 60 may be improved to suppress a decrease in an inductance due to the formation of the plating spreading prevention layer 60 and deterioration of direct current (DC) bias characteristics, improve a surface roughness, and prevent a plating spreading phenomenon.

The D₅₀ of the first magnetic powder particles 62 may be 1.5 μm to 3.5 μm, and the D₅₀ of the second magnetic powder particles 63 may be 0.3 μm to 1.5 μm.

The first and second magnetic powder particles 62 and 63 may be mixed with each other in a weight ratio of 8:2 to 2:8. The first and second magnetic powder particles 62 and 63 may be mixed with each other in a weight ratio within the above-mentioned range to improve the packing factor, such that the decrease in the inductance due to the formation of the plating spreading prevention layer 60 may be effectively suppressed.

FIG. 5 is an enlarged schematic view of another example of part ‘A’ of FIG. 2.

Referring to FIG. 5, the plating spreading prevention layer 60 may contain mixtures of first magnetic powder particles 62, second magnetic powder particles 63 having a D₅₀ smaller than that of the first magnetic powder particles 62, and third magnetic powder particles 64 having a D₅₀ smaller than that of the second magnetic powder particles 63.

As described above, the third magnetic powder particles 64 may be further mixed to further improve the packing factor. The packing factor of the magnetic powder particles contained in the plating spreading prevention layer may be improved to suppress a decrease in an inductance due to the formation of the plating spreading prevention layer 60 and deterioration of DC bias characteristics, improve a surface roughness, and prevent a plating spreading phenomenon.

The D₅₀ of the third magnetic powder particles 64 may be 0.1 μm to 0.3 μm.

The first and second magnetic powder particles 62 and 63 and the third magnetic powder particles 64 may be mixed with each other in a weight ratio (sum of weights of first and second magnetic powder particles:weight of third magnetic powder particles) of 9.5:0.5 to 7:3. The first magnetic powder particles 62, the second magnetic powder particles 63, and the third magnetic powder particles 64 maybe mixed with each other in a weight ratio within the above-mentioned range to improve the packing factor, such that the decrease in the inductance due to the formation of the plating spreading prevention layer 60 may be effectively suppressed.

In the plating spreading prevention layer 60 according to an exemplary embodiment of the present disclosure, the packing factor of the magnetic powder particles may be 50% to 90%.

In the case in which the packing factor is less than 50%, a relatively excessive amount of thermosetting resin may be contained in the plating spreading prevention layer 60 to flow in a hardening process, and in the case in which the packing factor exceeds 90%, the plating spreading prevention layer 60 maybe excessively brittle, such that it may be cracked or broken in a compression process.

Meanwhile, the plating spreading prevention layer 60 may further contain glass powder particles (not shown).

The glass powder particles contained in the plating spreading prevention layer 60 may be fine powder particles having a D₅₀ of 0.1 μm to 3.5 μm. Each of the glass powder particles contained in the plating spreading prevention layer 60 may have a particle size of 0.03 μm to 10 μm.

The glass powder may contain an oxide of one or more selected from the group consisting of zinc (Zn), copper (Cu), iron (Fe), silicon (Si), titanium (Ti), aluminum (Al), zirconium (Zr), bismuth (Bi), and boron (B).

The plating spreading prevention layer 60 according to an exemplary embodiment of the present disclosure may be formed by stacking a sheet formed of the fine powder particles as described above or applying pastes on at least one of the upper and lower surfaces of the magnetic body 50.

The plating spreading prevention layer 60 formed as described above may have a surface roughness lower than 0.5 μm. Therefore, the plating spreading phenomenon that may occur at the time of forming the plating layer of the external electrodes may be prevented.

As set forth above, according to exemplary embodiments of the present disclosure, the plating spreading phenomenon occurring on the surface of the chip electronic component at the time of forming the external electrodes may be prevented.

While exemplary embodiments have been shown and described above, it will be apparent to those skilled in the art that modifications and variations could be made without departing from the scope of the present invention as defined by the appended claims.

What is claimed is:

1. A chip electronic component comprising:
a magnetic body containing magnetic metal powder particles;
an internal coil part embedded in the magnetic body; and
a plating spreading prevention layer disposed on at least one of upper and lower surfaces of the magnetic body,
wherein the plating spreading prevention layer contains magnetic powder particles, and
a D₅₀ of the magnetic powder particles contained in the plating spreading prevention layer is 0.1 μm to 3.5 μm.

2. The chip electronic component of claim 1, wherein the magnetic powder particles contained in the plating spreading prevention layer are one or more selected from the group consisting of magnetic metal powder and ferrite.

3. The chip electronic component of claim 1, wherein the plating spreading prevention layer has a thickness of 15 μm or less.

4. The chip electronic component of claim 1, wherein the magnetic powder particles contained in the plating spreading prevention layer have a particle size of 0.03 μm to 10 μm.

5. The chip electronic component of claim 1, wherein the plating spreading prevention layer further contains glass powder particles, and
a D₅₀ of the glass powder particles is 0.1 μm to 3.5 μm.

6. The chip electronic component of claim 1, wherein the plating spreading prevention layer contains first magnetic powder particles and second magnetic powder particles having a D₅₀ smaller than that of the first magnetic powder particles, and
the D₅₀ of the first magnetic powder particles is 1.5 μm to 3.5 μm, and the D50 of the second magnetic powder particles is 0.3 μm to 1.5 μm.

7. The chip electronic component of claim 6, wherein the first and second magnetic powder particles are mixed with each other in a weight ratio of 8:2 to 2:8.

8. The chip electronic component of claim 6, wherein the plating spreading prevention layer further contains third magnetic powder particles having a D₅₀ smaller than that of the second magnetic powder particles, and
the D₅₀ of the third magnetic powder particles is 0.1 μm to 0.3 μm.

9. The chip electronic component of claim 8, wherein the first and second magnetic powder particles and the third magnetic powder particles are mixed with each other in a weight ratio of 9.5:0.5 to 7:3.

10. The chip electronic component of claim 1, wherein the plating spreading prevention layer further contains a thermosetting resin, and
a content of the thermosetting resin contained in the plating spreading prevention layer is 15 wt % to 30 wt %.

11. The chip electronic component of claim 1, wherein a packing factor of the magnetic powder particles in the plating spreading prevention layer is 50% to 90%.

12. The chip electronic component of claim 1, wherein the plating spreading prevention layer has a surface roughness lower than 0.5 μm.

13. The chip electronic component of claim 1, wherein the magnetic body contains first magnetic metal powder particles and second magnetic metal powder particles having a D₅₀ smaller than that of the first magnetic metal powder particles, and
the D₅₀ of the first magnetic metal powder particles is 18 μm to 22 μm, and the D₅₀ of the second magnetic metal powder particles is 2 μm to 4 μm.

14. A chip electronic component comprising:
a magnetic body containing magnetic metal powder particles;
an internal coil part embedded in the magnetic body; and
a fine powder cover layer disposed on at least one of upper and lower surfaces of the magnetic body,
wherein the fine powder cover layer contains magnetic powder particles having a particle size of 0.03 μm to 10 μm.

15. The chip electronic component of claim 14, wherein the magnetic powder particles are one or more selected from the group consisting of magnetic metal powder and ferrite.

16. The chip electronic component of claim 14, wherein the fine powder cover layer contains a thermosetting resin, and
a content of the thermosetting resin contained in the fine powder cover layer is 15 wt % to 30 wt %.

17. The chip electronic component of claim 14, wherein the fine powder cover layer has a surface roughness lower than 0.5 μm.

18. The chip electronic component of claim 14, wherein a packing factor of the magnetic powder particles in the fine powder cover layer is 50% to 90%.

19. The chip electronic component of claim 14, wherein the fine powder cover layer has a thickness of 15 μm or less.

20. The chip electronic component of claim 14, wherein the magnetic body contains first magnetic metal powder particles and second magnetic metal powder particles having an average particle size smaller than that of the first magnetic metal powder particles, and
the first magnetic metal powder particles have a particle size of 11 μm to 53 μm, and the second magnetic metal powder particles have a particle size of 0.5 μm to 6 μm.
